(19) United States
(12) Patent Application Publication
(10) Pub. No.: US 2011/0234622 A1
(43) Pub. Date: Sep. 29, 2011

(54) COLOR CORRECTION DEVICE AND COLOR CORRECTION METHOD

(75) Inventors: Nobuko FUJITA, Osaka (JP); Shinichi Tomioka, Osaka (JP); Atsuhisa Kageyama, Osaka (JP); Takaaki IInuma, Kyoto (JP); Koichi Inoue, Osaka (JP)

(73) Assignee: PANASONIC CORPORATION, Osaka (JP)

(21) Appl. No.: 13/156,834

(22) Filed: Jun. 9, 2011

Related U.S. Application Data
(63) Continuation of application No. PCT/JP2009/004074, filed on Aug. 24, 2009.

(30) Foreign Application Priority Data
Dec. 10, 2008 (JP) 2008-314152

(51) Int. Cl. G09G 5/02

(52) U.S. Cl. 345/591

(57) ABSTRACT

Complicated adjustment, such as adjusting hue and saturation by varying value for each hue in which hue correction and saturation correction are performed on only an input having a specific value of a specific color component, is performed. In a color space including hue Hi, saturation Si, and value Vi, calculating a hue correction value HVh and a saturation correction value HVs by using the hue Hi and the value Vi as parameters allows the hue correction and the saturation correction to be performed based on the value and completely independently for hue axes of the hue. The correction value calculating circuit scale has no influence on the complexity of the correction. It is possible to calculate the correction values by a certain circuit scale no matter how complicated the correction is.

### CROSS-REFERENCE TO RELATED APPLICATION

This is a continuation of PCT International Application PCT/JP2009/004074 filed on Aug. 24, 2009, which claims priority to Japanese Patent Application No. 2008-314152 filed on Dec. 10, 2008. The disclosures of these applications including the specifications, the drawings, and the claims are hereby incorporated by reference in their entirety.

### BACKGROUND

The present disclosure relates to color correction devices configured to adjust hue and saturation based on the characteristics of input images, and to color correction methods.

In an HSV color space adjusting process, color signals are converted to a color space including three components, hue (H) representing types of colors, saturation (S) representing vividness of the colors, and value (V) representing brightness of the colors, and then are adjusted. The HSV color space adjusting process can independently process hue, saturation, and value, and thus is widely used to adjust the saturation and the value. The process is performed in a manner such that the color space of input color signals is converted (or translated) to the HSV color space represented by hue (H), saturation (S), and value (V), and preferable adjustment is performed in the HSV color space, and then the HSV color space is converted back to the original color space of the input color signals. Hue (H), which is one of the three components of the HSV color space, is expressed in angle, and six hue axes of red, yellow, green, cyan, blue, and magenta are measured at 60-degree intervals with the hue of the red starting at 0 degrees.

Moreover, when the input color signals are displayed on a display such as a monitor, a color conversion process based on the characteristic of a monitor on which the input color signals are displayed, or a color conversion process taking into account human visual perception or memory color are performed. True color reproduction does not necessarily provide an image which humans perceive to be preferable. Blue of the sky, a skin color of humans, pink of cherry blossoms, etc., known as memory colors are memorized as colors having saturation and value higher than true colors. For this reason, processes to increase the value and the saturation of such specific color components are performed. In particular, complicated adjustment, for example, adjusting hue and saturation for each color based on variations of value is required. Examples of the complicated adjustment include performing hue correction on only an input having a specific value of a specific color component, performing saturation correction on only an input having a specific value of a specific color component, etc.

Japanese Patent No. 3784726 discloses an example technique for performing such complicated adjustment. In a color adjusting device disclosed in Japanese Patent No. 3784726, the color space of input color signals Ri, Gi, and Bi is converted from the RGB color space to the HSV color space, thereby obtaining hue Hi, saturation Si, and value Vi. A hue adjustment value Hh, a saturation adjustment value Hs, and a value adjustment value Hv are calculated, where the hue Hi is an input. A hue adjustment value Sh, a saturation adjustment value Ss, and a value adjustment value Sv are calculated, where the saturation Si is an input. A hue adjustment value Vh, a saturation adjustment value Vs, and a value adjustment value Vv are calculated, where the value Vi is an input. The hue adjustment values Hh, Sh, and Vh are used to adjust the hue Hi. The saturation adjustment values Hs, Ss, and Vs are used to adjust the saturation Si. The value adjustment values Hv, Sv, and Vv are used to adjust the value Vi. The color space of hue Ho, saturation So, and value Vo after the adjustment is converted from the HSV color space back to the original RGB color space, thereby obtaining output color signals Ro, Go, and Bo. In this way, the complicated adjustment such as adjusting saturation and value for each color, adjusting saturation based on the variations of value, etc. can be made.

### SUMMARY

However, in the color adjusting device disclosed in Japanese Patent No. 3784726, when it is attempted to, for example, calculate, for an input having a hue of the red area, a hue correction value Vh for only a signal having a value Vi around an intermediate level between 0 and MAX (maximum value) by using a trapezoidal correction function Fh (Vi) as illustrated in FIG. 2A, and calculate, for an input having a hue of the yellow area, a hue correction value Vh by using a sinusoidal correction function Fh (Vi) as illustrated in FIG. 2B, one circuit configured to receive a value Vi to calculate a hue adjustment value Vh (“adjustment value calculating device 4 based on the value” of FIG. 1 of Japanese Patent No. 3784726) cannot completely differently and independently correct the hue of the red area and the hue of the yellow area. Two circuits as the circuit configured to receive a value Vi to calculate a hue adjustment value Vh (“adjustment value calculating device 4 based on the value” of FIG. 1 of Japanese Patent No. 3784726) have to be provided. Moreover, hue correction based on value Vi cannot be completely independently performed on red, yellow, green, cyan, blue, and magenta, which are colors of six hue axes, with one circuit configured to receive a value Vi to calculate a hue adjustment value Vh (“adjustment value calculating device 4 based on the value” of FIG. 1 of Japanese Patent No. 3784726). The circuit configured to receive a value Vi to calculate a hue adjustment value Vh (“adjustment value calculating device 4 based on the value” of FIG. 1 of Japanese Patent No. 3784726) has to be provided for each of the six hue axes (six circuits in total).

Likewise, in the color adjusting device disclosed in Japanese Patent No. 3784726, for example, saturation correction cannot be completely differently and independently performed on the red area and the yellow area with one circuit for receiving value Vi and calculating the saturation adjustment value Vs (“adjustment value calculating device 4 based on the value” of FIG. 1 of Japanese Patent No. 3784726). Two circuits as the circuit configured to receive a value Vi to calculate a saturation adjustment value Vs (“adjustment value calculating device 4 based on the value” of FIG. 1 of Japanese Patent No. 3784726) have to be provided. Moreover, the saturation correction based on value Vi cannot be completely independently performed on the red, yellow, green, cyan, blue, and magenta, which are the colors of the six hue axes, with one circuit configured to receive a value Vi to calculate a saturation adjustment value Vs (“adjustment value calculating device 4 based on the value” of FIG. 1 of Japanese Patent No. 3784726). The circuit configured to receive a value Vi to calculate a saturation adjustment value Vs (“adjustment value calculating device 4 based on the value” of FIG. 1 of Japanese Patent No. 3784726) has to be provided for each of the six hue axes (six circuits in total).

An example color correction device of the present invention includes a color space converter configured to convert an input color signal to hue, saturation, and value; a hue correction value calculator configured to calculate a hue correction value based on the hue and the value from the color space converter; a hue corrector configured to correct the hue from the color space converter based on the hue correction value from the hue correction value calculator; and a color space inverse converter configured to subject the hue corrected by the hue corrector and the saturation and the value from the color space converter to conversion performed in a manner inverse to the conversion performed with the color space converter, wherein the hue correction value calculator contains individual hue correction functions respectively preset for at least two of red, yellow, green, cyan, blue, and magenta, which are colors of six hue axes, each of the hue correction functions takes the value as an input parameter, and returns the hue correction value as an output, and the hue correction value calculator determines to which one of color areas of the red, yellow, green, cyan, blue, and magenta, which are the colors of the six hue axes, the hue from the color space converter belongs, and calculates the hue correction value based on the hue correction function specified for the determined color area and the value from the color space converter.

With the color correction device, hue correction based on the value can be completely independently performed on the red, yellow, green, cyan, blue, and magenta, which are the colors of the six hue axes.

Moreover, the hue correction value calculator of the color correction device includes a color area determiner, a value level area determiner, a correction amount parameter selector, a correction value calculating circuit, a first look-up table, and a second look-up table, the first look-up table contains at least two first tables respectively associated with at least two of the color areas of the red, yellow, green, cyan, blue, and magenta, which are the colors of the six hue axes, each of the first tables specifies preset ranges of the value of N areas obtained by dividing a range from a minimum value to a maximum value of the value of the corresponding color area by N, the second look-up table contains at least two second tables respectively associated with at least two of the color areas of the red, yellow, green, cyan, blue, and magenta, which are the colors of the six hue axes, each of the second tables specifies correction amount parameters preset for the N areas of the corresponding color area, each of the correction amount parameters represents a correction function of the corresponding color area, and the correction function takes the value as an input parameter, and returns the hue correction value as an output, the color area determiner determines to which one of the color areas of the red, yellow, green, cyan, blue, and magenta, which are the colors of the six hue axes, the hue from the color space converter belongs, and outputs a result of the determination as a color area determination result, the value level area determiner refers to one of the first tables contained in the first look-up table which corresponds to the color area determination result from the color area determiner, determines to which one of the N areas specified in the table the value from the color space converter belongs, and outputs a result of the determination as a value level determination result, the correction amount parameter selector refers to one of the second tables contained in the second look-up table which corresponds to the color area determination result from the color area determiner, obtains, from the table, the correction amount parameter specified for the value level determination result from the value level area determiner, and outputs the obtained correction amount parameter, and the correction value calculating circuit calculates the hue correction value based on the correction amount parameter from the correction amount parameter selector and the value from the color space converter.

With the color correction device, the circuit scale of the hue correction value calculator has no influence on the complexity of the correction. It is possible to calculate the correction value by a certain circuit scale no matter haw complex the correction is.

Another example color correction device of the present invention includes a color space converter configured to convert an input color signal to hue, saturation, and value; a saturation correction value calculator configured to calculate a saturation correction value based on the hue and the value from the color space converter; a saturation corrector configured to correct the saturation from the color space converter based on the saturation correction value from the saturation correction value calculator; and a color space inverse converter configured to subject the saturation corrected by the saturation corrector and the hue and the value from the color space converter to conversion performed in a manner inverse to the conversion performed with the color space converter, wherein the saturation correction value calculator contains individual saturation correction functions respectively preset for at least two of red, yellow, green, cyan, blue, and magenta, which are colors of six hue axes, each of the saturation correction functions takes the value as an input parameter, and returns the saturation correction value as an output, and the saturation correction value calculator determines to which one of color areas of the red, yellow, green, cyan, blue, and magenta, which are the colors of the six hue axes, the hue from the color space converter belongs, and calculates the saturation correction value based on the saturation correction function specified for the determined color area and the value from the color space converter.

With the color correction device, saturation correction based on the value can be completely independently performed on red, yellow, green, cyan, blue, and magenta, which are six hue axes of the hue.

Moreover, the saturation correction value calculator of the color correction device includes a color area determiner, a value level area determiner, a correction amount parameter selector, a correction value calculating circuit, a first look-up table, and a second look-up table, the first look-up table contains at least two first tables respectively associated with at least two of the color areas of the red, yellow, green, cyan, blue, and magenta, which are the colors of the six hue axes, each of the first tables specifies preset ranges of the value of N areas obtained by dividing a range from a minimum value to a maximum value of the value of the corresponding color area by N, the second look-up table contains at least two second tables respectively associated with at least two of the color areas of the red, yellow, green, cyan, blue, and magenta, which are the colors of the six hue axes, each of the second tables specifies correction amount parameters preset for the N areas of the corresponding color area, each of the correction amount parameters represents a correction function of the corresponding color area, and the correction function takes the value as an input parameter, and returns the saturation correction value as an output, the color area determiner determines to which one of the color areas of the red, yellow, green, cyan, blue, and magenta, which are the colors of the six hue axes, the hue from the color space converter belongs, and outputs a result of the determination as a color area determination result, the value level area determiner refers to one of the first tables contained in the first look-up table which corresponds to the color area determination result from the color area determiner, determines to which one of the N areas specified in the table the value from the color space converter belongs, and outputs a result of the determination as a value level determination result, the correction amount parameter selector refers to one of the second tables contained in the second look-up table which corresponds to the color area determination result from the color area determiner, obtains, from the table, the correction amount parameter specified for the value level determination result from the value level area determiner, and outputs the obtained correction amount parameter, and the correction value calculating circuit calculates the saturation correction value based on the correction amount parameter from the correction amount parameter selector and the value from the color space converter.

With the color correction device, the circuit scale of the saturation correction value calculator has no influence on the complexity of the correction. It is possible to calculate the correction value by a certain circuit scale no matter how complicated the correction is.

According to the color correction device of the present invention, the hue correction and/or the saturation correction based on the value can be completely independently performed on the red, yellow, green, cyan, blue, and magenta, which are the colors of the six hue axes.

Moreover, the circuit scale of the hue correction value calculator and/or the saturation correction value calculator has no influence on the complexity of the correction. It is possible to calculate the correction value by a certain circuit scale no matter how complex the correction is.

### BRIEF DESCRIPTION OF THE DRAWINGS

FIG. 1 is a block diagram illustrating the entire configuration of a color correction device of a first embodiment of the present invention.

FIG. 2A is a view illustrating an example hue correction function in the red area.

FIG. 2B is a view illustrating an example hue correction function in the yellow area.

FIG. 3 is a block diagram illustrating an internal configuration of a hue correction value calculator 2 of a color correction device of a second embodiment of the present invention.

FIG. 4A is a view illustrating an example hue correction function in the red area.

FIG. 4B is a view illustrating an example hue correction function in the yellow area.

FIG. 5 is a block diagram illustrating the entire configuration of a television set of a third embodiment of the present invention.

### DETAILED DESCRIPTION

Embodiments of the present invention will be described below with reference to the drawings.

### First Embodiment

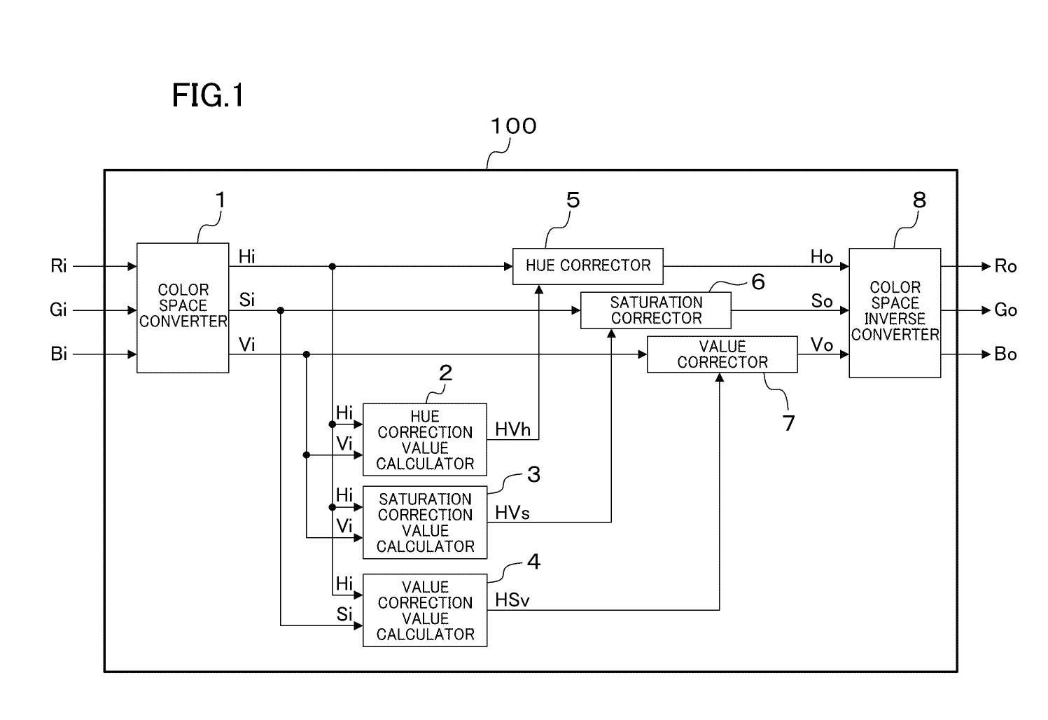

FIG. 1 illustrates an entire configuration of a color correction device of a first embodiment of the present invention. A color correction device 100 includes a color space converter 1, a hue correction value calculator 2, a saturation correction value calculator 3, a value correction value calculator 4, a hue corrector 5, a saturation corrector 6, a value corrector 7, and a color space inverse converter 8.

The color space converter 1 converts input color signals Ri, Gi, and Bi to hue Hi, saturation Si, and value Vi, and outputs the obtained hue Hi, saturation Si, and value Vi. The conversion is performed using a known color space conversion formula from the RGB color space to the HSV color space.

The hue correction value calculator 2 calculates a hue correction value HVh based on the hue Hi and the value Vi which are output from the color space converter 1. The saturation correction value calculator 3 calculates a saturation correction value HVs based on the hue Hi and the value Vi which are output from the color space converter 1. The value correction value calculator 4 calculates a value correction value HSv based on the hue Hi and the saturation Si which are output from the color space converter 1.

The hue corrector 5 corrects the hue Hi output from the color space converter 1 based on the hue correction value HVh from the hue correction value calculator 2, and outputs a corrected hue Ho. The saturation corrector 6 corrects the saturation Si output from the color space converter 1 based on the saturation correction value HVs from the saturation correction value calculator 3, and outputs a corrected saturation So. The value corrector 7 corrects the value Vi output from the color space converter 1 based on the value correction value HSv from the value correction value calculator 4, and outputs a corrected value Vo.

The color space inverse converter 8 converts the corrected hue Ho, saturation So, and value Vo to color signals Ro, Go, and Bo, and outputs the converted color signals Ro, Go, and Bo. The conversion is performed using a known color space conversion formula from the HSV color space to the RGB color space.

The hue correction value calculator 2 receives the hue Hi and the value Vi which are output from the color space converter 1, and outputs the hue correction value HVh specified by using the hue Hi and the value Vi as parameters.

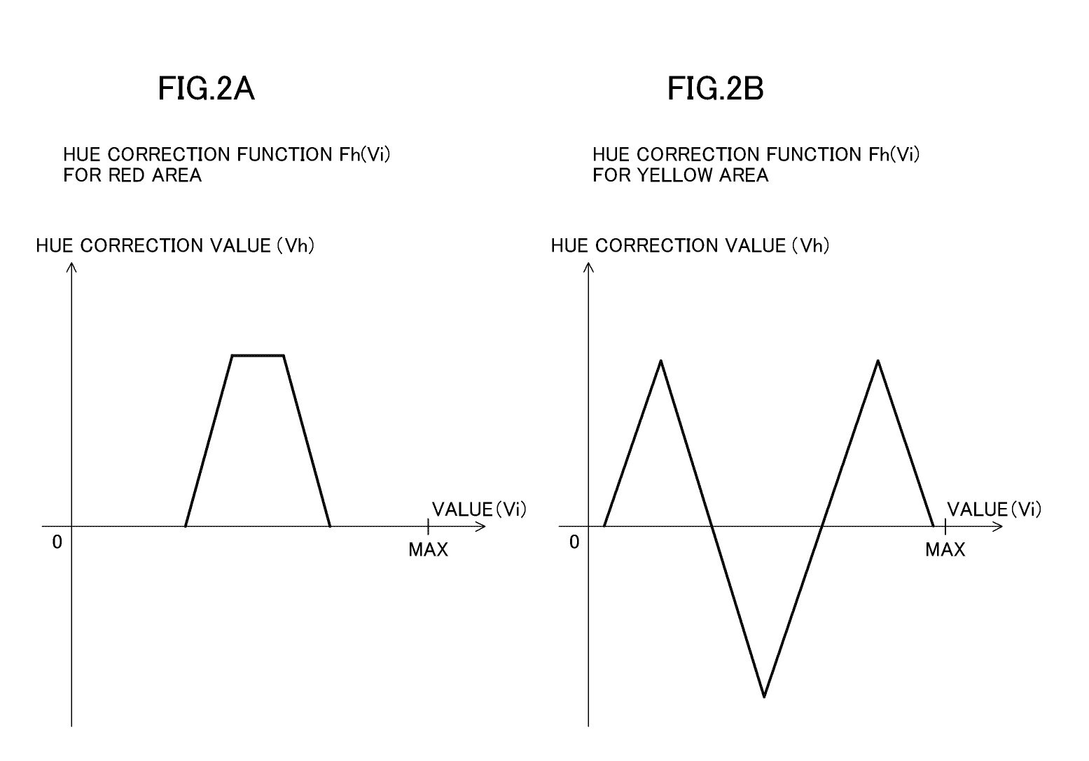

The hue correction value calculator 2 contains individual hue correction functions Fh (Vi) respectively preset for red, yellow, green, cyan, blue, and magenta, which are colors of six hue axes. These hue correction functions Fh (Vi) are functions each take the value Vi as an input, and return a hue correction value Vh as an output. The individual hue correction functions Fh (Vi) are respectively specified for color areas. For example, a trapezoidal correction function Fh (Vi) as illustrated in FIG. 2A is specified for the red area, and a sinusoidal correction function Fh (Vi) as illustrated in FIG. 2B is specified for the yellow area.

The hue correction value calculator 2 determines to which one of the red, yellow, green, cyan, blue, and magenta, which are the colors of the six hue axes, the hue Hi received from the color space converter 1 belongs. The hue correction value calculator 2 calculates the hue correction value Vh based on the hue correction function Fh (Vi) specified for the determined color area and the value Vi received from the color space converter 1. The hue correction value calculator 2 outputs the calculated hue correction value Vh as the hue correction value HVh to the hue corrector 5.

In this way, the hue correction value calculator 2 calculates, for example, for an input having a hue of the red area, a hue correction value Vh for only a signal having a value Vi around the intermediate level between 0 (minimum value) and MAX (maximum value) based on the trapezoidal correction function Fh (Vi) as illustrated in FIG. 2A, and calculates, for an input having a hue of the yellow area, positive hue correction values Vh for a signal having a low value Vi and a signal having a high value Vi, and a negative hue correction value Vh for a signal having an intermediate level value Vi based on the sinusoidal correction function Fh (Vi) as illustrated in FIG. 2B. Thus, the hue correction value calculator 2 differently and independently performs hue correction on the red area and the yellow area. Likewise, the hue correction value calculator 2 calculates, also for inputs having hues of the green area, cyan area, blue area, and magenta area, hue correction values Vh based on hue correction functions Fh (Vi) respectively specified for the color areas, thereby differently and independently performing the hue correction on the green area, cyan area, blue area, and magenta area.

As described above, the hue correction value calculator 2 of the present embodiment can completely independently perform the hue correction on the red, yellow, green, cyan, blue, and magenta, which are the colors of the six hue axes based on the value Vi.

Note that hue correction functions Fh (Vi) are not necessarily preset for all the six hue axes, but may be preset for at least two of the six hue axes of the hue. In this case, the hue correction value calculator 2 does not calculate the hue correction value HVh when the hue Hi received from the color space converter 1 belongs to a color area for which the hue correction function Fh (Vi) is not specified (for example, 0 (no correction) is output as the hue correction value HVh).

The saturation correction value calculator 3 receives the hue Hi and the value Vi which are output from the color space converter 1, and outputs the saturation correction value HVs calculated using the hue Hi and the value Vi as parameters.

The saturation correction value calculator 3 contains preset individual hue correction functions Fs (Vi) respectively for the red, yellow, green, cyan, blue, and magenta, which are the colors of the six hue axes. These saturation correction functions Fs (Vi) are functions each take the value Vi as an input, and return a saturation correction value Vs as an output.

The saturation correction value calculator 3 determines to which one of the red, yellow, green, cyan, blue, and magenta, which are the colors of the six hue axes, the hue Hi received from the color space converter 1 belongs. The saturation correction value calculator 3 calculates the saturation correction value Vs based on the saturation correction function Fs (Vi) specified for the determined color area and the value Vi received from the color space converter 1. The saturation correction value calculator 3 outputs the calculated saturation correction value Vs as the saturation correction value HVs to the saturation corrector 6.

In a manner similar to that performed in the hue correction value calculator 2, the saturation correction value calculator 3 calculates, for inputs having hues of the red area, yellow area, green area, cyan area, blue area, and magenta area, saturation correction values Vs based on saturation correction functions Fs (Vi) respectively specified for the color areas, thereby differently and independently performing saturation correction on the red area, yellow area, green area, cyan area, blue area, and magenta area.

As described above, the saturation correction value calculator 3 of the present embodiment can completely independently perform the saturation correction on the red, yellow, green, cyan, blue, and magenta, which are the colors of the six hue axes, based on the value Vi.

Note that saturation correction functions Fs (Vi) are not necessarily preset for all the six hue axes, but may be preset for at least two of the six hue axes of the hue. In this case, the saturation correction value calculator 3 does not calculate the saturation correction value HVs when the hue Hi received from the color space converter 1 belongs to a color area for which the hue correction function Fs (Vi) is not specified (for example, 0 (no correction) is output as the saturation correction value HVs).

The value correction value calculator 4 receives the hue Hi and the saturation Si which are output from the color space converter 1, and outputs the value correction value HSv specified by using the hue Hi and the saturation Si as parameters.

The value correction value calculator 4 contains preset individual value correction gains respectively for the red, yellow, green, cyan, blue, and magenta, which are the colors of the six hue axes. The value correction value calculator 4 further contains preset value correction functions Fv (Si) each of which takes the saturation Si as an input, and returns a value correction value Vv as an output. The value correction functions Fv (Si) are functions each with the feature of reducing the amount of value correction when the saturation Si is low so that excessive value correction on achromatic colors (black-white) is prevented.

The value correction value calculator 4 determines to which one of the red, yellow, green, cyan, blue, and magenta, which are the colors of the six hue axes, the hue Hi received from the color space converter 1 belongs. The value correction value calculator 4 calculates the value correction value HSv by multiplying the value correction gain specified for the determined color area by the value correction value Vv obtained by inputting the saturation Si received from the color space converter 1 to the value correction function Fv (Si). The value correction value calculator 4 outputs the calculated value correction value HSv to the value corrector 7.

As described above, the value correction value calculator 4 of the present embodiment can independently perform the value correction on the red, yellow, green, cyan, blue, and magenta, which are the colors of the six hue axes, and can perform suitable value correction on the achromatic colors.

Note that the value correction gains are not necessarily preset for all the six hue axes, but may be preset for at least two of the six hue axes of the hue. In this case, the value correction value calculator 4 does not calculate the value correction value HSv when the hue Hi received from the color space converter 1 belongs to a color area for which the value correction gain is not specified (for example, 0 (no correction) is output as the value correction value HSv).

### Second Embodiment

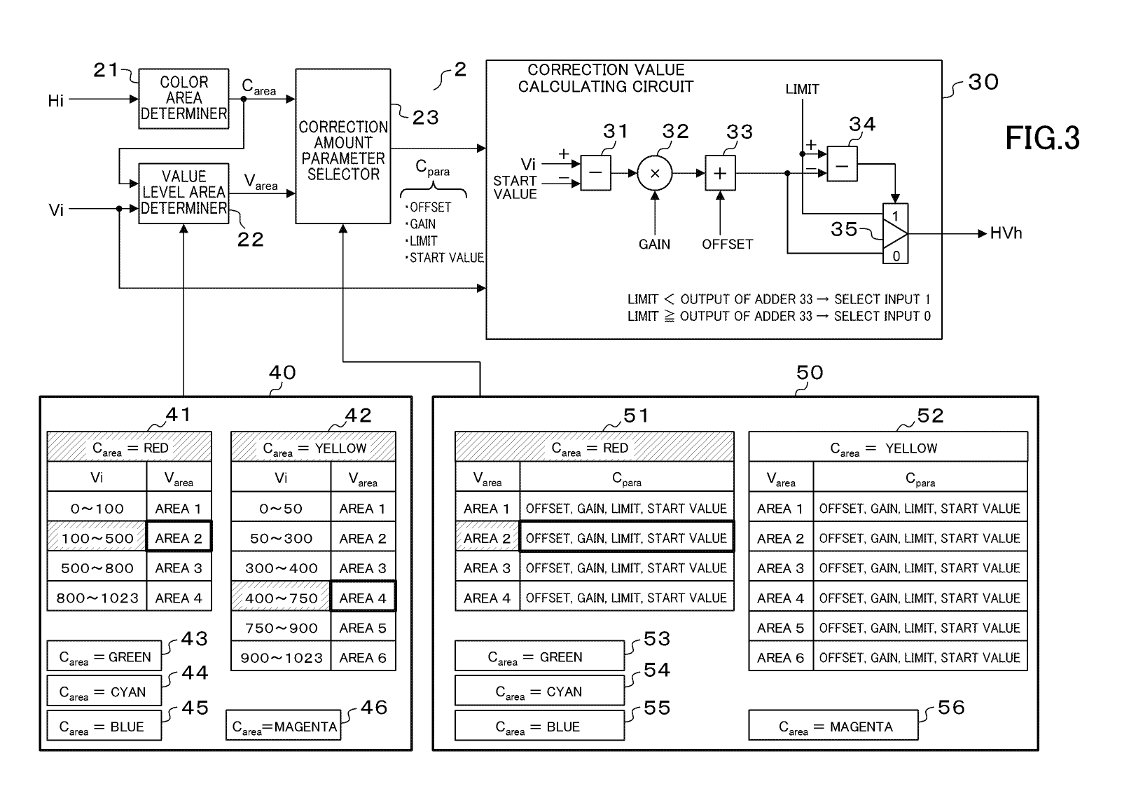

An entire configuration of a color correction device of a second embodiment of the present invention is substantially the same as that of FIG. 1. FIG. 3 is a block diagram illustrating an internal configuration of a hue correction value calculator 2 of the color correction device of the second embodiment.

The hue correction value calculator 2 illustrated in FIG. 3 includes a color area determiner 21, a value level area determiner 22, a correction amount parameter selector 23, a correction value calculating circuit 30, and look-up tables 40, 50.

The look-up table 40 contains six tables 41-46 respectively associated with color areas Cₐᵣₑₐ of red, yellow, green, cyan, blue, and magenta, which are colors of six hue axes.

Each of the table 41-46 specifies preset ranges of the value Vi of N areas Vₐᵣₑₐ obtained by dividing the range from a minimum value (=0 here) to a maximum value (=1023 here) of the value Vi in the corresponding color area Cₐᵣₑₐ by N. Note that the division number N and the ranges of the value Vi of the areas Vₐᵣₑₐ may be different for each color area Cₐᵣₑₐ.

The table 41 is associated with the red area (Cₐᵣₑₐ=red). Here, the division number N of the red area is four, and the range from a minimum value (=0 here) to a maximum value (=1023 here) of the value Vi is divided into four areas Vₐᵣₑₐ (Areas 1-4). The table 41 specifies the range of the value Vi of each of the areas Vₐᵣₑₐ (Areas 1-4). The range of the value Vi of Area 1 is 0-100, the range of the value Vi of Area 2 is 100-500, the range of the value Vi of Area 3 is 500-800, and the range of the value Vi of Area 4 is 800-1023.

The table 42 is associated with the yellow area (Cₐᵣₑₐ=yellow). Here, the division number N of the yellow area is six, and the range from a minimum value (=0 here) to a maximum value (=1023 here) of the value Vi is divided into six areas Vₐᵣₑₐ (Areas 1-6). The table 42 specifies the range of the value Vi of each of the areas Vₐᵣₑₐ (Areas 1-6). The range of the value Vi of Area 1 is 0-50, the range of the value Vi of Area 2 is 50-300, the range of the value Vi of Area 3 is 300-400, the range of the value Vi of Area 4 is 400-750, the range of the value Vi of Area 5 is 750-900, and the range of the value Vi of Area 6 is 900-1023.

Likewise, the tables 43-46 are associated with the green area (Cₐᵣₑₐ=green), cyan area (Cₐᵣₑₐ=cyan), blue area (Cₐᵣₑₐ=blue), and magenta area (Cₐᵣₑₐ=magenta), respectively. The division number N varies for each of the color areas, and the range from a minimum value (=0 here) to a maximum value (=1023 here) of the value Vi is divided into N areas Vₐᵣₑₐ (Areas 1-N). The tables 43-46 specify the ranges of the value Vi of the areas Vₐᵣₑₐ (Areas 1-N).

The look-up table 50 contains six tables 51-56 respectively associated with the color areas Cₐᵣₑₐ of the red, yellow, green, cyan, blue, and magenta, which are the colors of the six hue axes.

Each of the tables 51-56 specifies a correction amount parameter Cₚₐᵣₐ preset for each of N areas Vₐᵣₑₐ of the corresponding color area Cₐᵣₑₐ. The correction amount parameter Cₚₐᵣₐ each represent a correction function of the corresponding color area Cₐᵣₑₐ. The correction function takes the value Vi as an input parameter, and returns a correction value HVh as an output. The correction amount parameter Cₚₐᵣₐ may include a plurality of correction amount parameters, and herein, an offset, a gain, a limit, and a start value are specified as correction amount parameters Cₚₐᵣₐ.

The start value represents the start value of the range of the value Vi of the corresponding area Vₐᵣₑₐ. For example, for four areas Vₐᵣₑₐ (Areas 1-4) of the red area (Cₐᵣₑₐ=red), the start value of Area 1 is 0, the start value of Area 2 is 100, the start value of Area 3 is 500, and the start value of Area 4 is 800. These start values are specified as start values of Areas 1-4 in the table 51. The offset represents the correction value HVh at the start value of the range of the value Vi of the corresponding area Vₐᵣₑₐ. The gain represents the inclination of the correction value HVh in the range of the value Vi of the corresponding area Vₐᵣₑₐ. The limit represents the limit value of the correction value HVh in the range of the value Vi of the corresponding area Vₐᵣₑₐ.

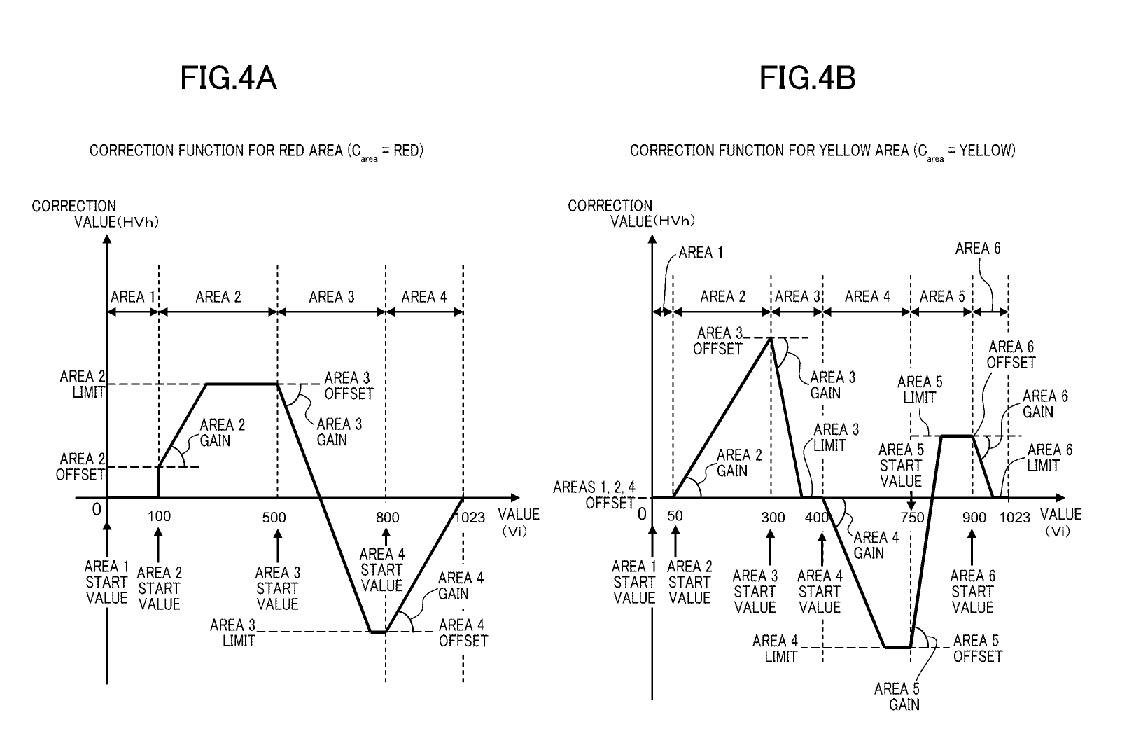

The table 51 contains correction amount parameters Cₚₐᵣₐ (offset, gain, limit, and start value) respectively preset for four areas Vₐᵣₑₐ (Areas 1-4) of the red area (Cₐᵣₑₐ=red). Based on the correction amount parameters Cₚₐᵣₐ, a correction function of the red area (Cₐᵣₑₐ=red) is defined, for example, as illustrated in FIG. 4A. The table 52 contains correction amount parameters Cₚₐᵣₐ (offset, gain, limit, start value) respectively preset for six areas Vₐᵣₑₐ (Areas 1-6) of the yellow area (Cₐᵣₑₐ=yellow). Based on the correction amount parameters Cₚₐᵣₐ, a correction function of the yellow area (Cₐᵣₑₐ=yellow) is defined, for example, as illustrated in FIG. 4B. Likewise, the tables 53-56 contain correction amount parameters Cₚₐᵣₐ (offset, gain, limit, start value) preset for N areas Vₐᵣₑₐ (Area 1-N) of the green area (Cₐᵣₑₐ=green), the cyan area (Cₐᵣₑₐ=cyan), the blue area (Cₐᵣₑₐ=blue), and the magenta area (Cₐᵣₑₐ=magenta), respectively. Based on the correction amount parameters Cₚₐᵣₐ, correction functions of the green area (Cₐᵣₑₐ=green), the cyan area (Cₐᵣₑₐ=cyan), the blue area (Cₐᵣₑₐ=blue), and the magenta area (Cₐᵣₑₐ=magenta) are defined, respectively. In this way, the correction functions are completely independently defined for each of the color areas of red, yellow, green, cyan, blue, magenta, which are colors of six hue axes.

The color area determiner 21 of the hue correction value calculator 2 illustrated in FIG. 3 receives the hue Hi from the color space converter 1 (FIG. 1). The color area determiner 21 determines to which one of the color areas of the red, yellow, green, cyan, blue, and magenta, which are the colors of the six hue axes, the received hue Hi belongs, and outputs the result of the determination as a color area determination result Cₐᵣₑₐ.

The value level area determiner 22 receives the color area determination result Cₐᵣₑₐ from the color area determiner 21 and the value Vi from the color space converter 1. The value level area determiner 22 refers to one of the tables 41-46 contained in the look-up which corresponds to the color area determination result Cₐᵣₑₐ from the color area determiner 21, determines to which one of the N areas Vₐᵣₑₐ (Areas 1-N) specified in the table the value Vi from the color space converter 1 belongs, and outputs a result of the determination as a value level determination result Vₐᵣₑₐ. For example, when the look-up table 40 contains the tables 41-46 as described above (see FIG. 3), if the color area determination result Cₐᵣₑₐ from the color area determiner 21 is “red,” and the value Vi from the color space converter 1 is “400,” the value level determination result Vₐᵣₑₐ is “Area 2,” and if the color area determination result Cₐᵣₑₐ from the color area determiner 21 is “yellow,” and the value Vi from the color space converter 1 is “700,” the value level determination result Vₐᵣₑₐ is “Area 4.”

The correction amount parameter selector 23 receives the color area determination result Cₐᵣₑₐ from the color area determiner 21 and the value level determination result Vₐᵣₑₐ from the value level area determiner 22. The correction amount parameter selector 23 refers to one of the tables 51-56 contained in the look-up table 50 which corresponds to the color area determination result Cₐᵣₑₐ from the color area determiner 21, obtains, from the table, correction amount parameters Cₚₐᵣₐ specified for the value level determination result Vₐᵣₑₐ from the value level area determiner 22, and outputs the obtained correction amount parameters Cₚₐᵣₐ. For example, when the look-up tables 40, 50 contain the tables 41-46, and 51-56 as described above (see FIG. 3), if the color area determination result Cₐᵣₑₐ from the color area determiner 21 is “red,” and the value level determination result Vₐᵣₑₐ from the value level area determiner 22 is “Area 2,” the correction amount parameter selector 23 obtains correction amount parameters Cₚₐᵣₐ (offset, gain, limit, start value) specified for Area 2 in the table 51, and outputs the obtained correction amount parameters Cₚₐᵣₐ.

The correction value calculating circuit 30 receives the correction amount parameters Cₚₐᵣₐ (offset, gain, limit, start value) from the correction amount parameter selector 23, and the value Vi from the color space converter 1. The correction value calculating circuit 30 includes subtracters 31, 34, a multiplier 32, an adder 33, and a selector 35.

The subtracter 31 subtracts the correction amount parameter Cₚₐᵣₐ (start value) received from the correction amount parameter selector 23 from the value Vi received from the color space converter 1, and outputs the result of the subtraction (Vi−start value).

The multiplier 32 multiplies the correction amount parameter Cₚₐᵣₐ (gain) from the correction amount parameter selector 23 by the output (Vi−start value) of the subtracter 31, and outputs the result of the multiplication (gain×(Vi−start value)).

The adder 33 adds the correction amount parameter Cₚₐᵣₐ (offset) from the correction amount parameter selector 23 to the output (gain×(Vi−start value)) of the multiplier 32, and outputs the result of the addition (offset+gain×(Vi−start value)).

The subtracter 34 subtracts the output (offset+gain×(Vi−start value)) of the adder 33 from the correction amount parameter Cₚₐᵣₐ (limit) received from the correction amount parameter selector 23, and outputs the result of the subtraction (limit−(offset+gain×(Vi−start value))).

The output (offset+gain×(Vi−start value)) of the adder 33 is input to an input 0 of the selector 35, and the correction amount parameter Cₚₐᵣₐ (limit) from correction amount parameter selector 23 is input to an input 1 of the selector 35. When the output of the subtracter 34 is 0 or greater, that is, (limit) (output of the adder 33), the selector 35 selects the input 0, that is, the output (offset+gain×(Vi×start value)) of the adder 33, and outputs the selected output (offset+gain×(Vi−start value)) as the correction value HVh. By contrast, when the output of the subtracter 34 is negative, that is, (limit)<(output of the adder 33), the selector 35 selects the input 1, that is, the correction amount parameter Cₚₐᵣₐ (limit), and outputs the selected correction amount parameter Cₚₐᵣₐ as the correction value HVh.

FIGS. 4A and 4B illustrate examples of the correction functions. To obtain the correction value HVh using a more complex correction function, the division number N is increased so that an approximately complex correction function can be defined. In this case, although the number of preset values to be specified in the tables 41-46, and 51-56 of the look-up tables 40, 50 increases, correction amount parameters Cₚₐᵣₐ corresponding to one Area are selected by the correction amount parameter selector 23, and are used in the correction value calculating circuit 30 to calculate the correction value HVh, so that the circuit scale of the correction value calculating circuit 30 is not increased.

Although the look-up tables 40, 50 of the above description contain the tables 41-46 and 51-56 for all the color areas Cₐᵣₑₐ of the red, yellow, green, cyan, blue, and magenta, which are the colors of the six hue axes, the look-up tables 40, 50 may contain similar tables preset for at least two of the six hue axes of the hue. In this case, the correction value calculating circuit 30 does not calculate the hue correction value HVh (for example, zero (no correction) is output as the hue correction value HVh) when the hue Hi received from the color space converter 1 belongs to a color area Cₐᵣₑₐ for which the table is not specified.

Although the internal configuration and operation of the hue correction value calculator 2 have been described in the present embodiment, the saturation correction value calculator 3 (FIG. 1) can also have an internal configuration similar to the configuration illustrated in FIG. 3.

### Third Embodiment

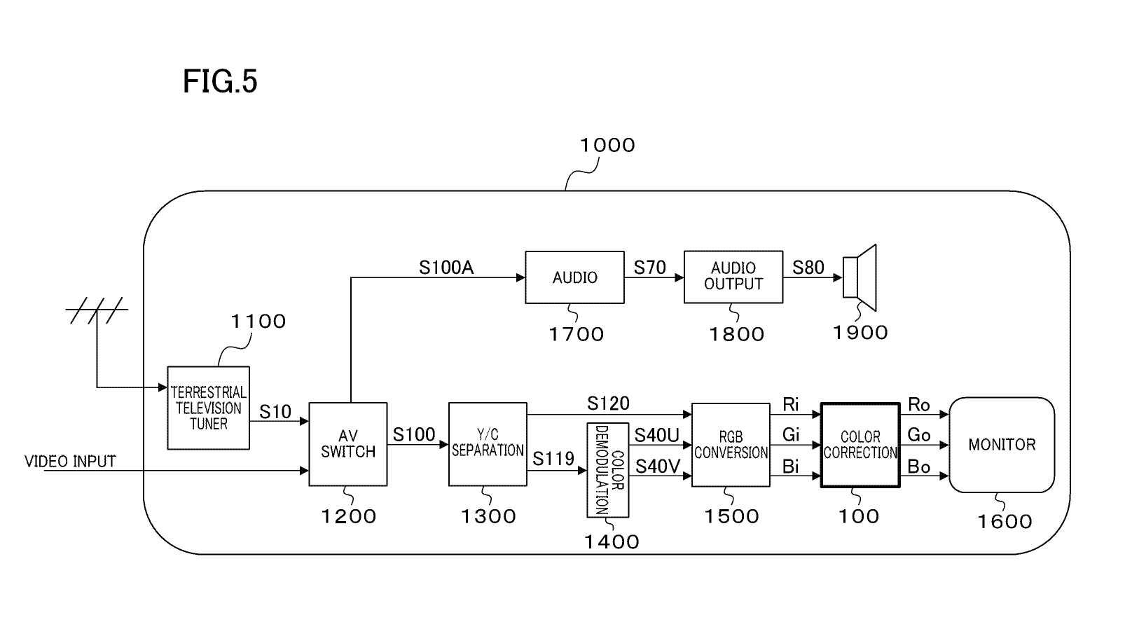

FIG. 5 is a block diagram illustrating the entire configuration of a television set of a third embodiment of the present invention. A television receiver 1000 of the present embodiment includes a terrestrial television tuner 1100, an AV switch 1200, a Y/C separation circuit 1300, a color demodulator circuit 1400, an RGB conversion circuit 1500, a color correction circuit 100, a monitor screen 1600, an audio processing circuit 1700, an audio output circuit 1800, and a speaker 1900.

The terrestrial television tuner 1100 receives broadcasts respectively assigned to channels. The AV switch 1200 switches between a ground-based broadcasting signal S10 received by the tuner 1100, and a video signal and an audio signal (Video inputs) input from an external device such as a DVD recorder. The Y/C separation circuit 1300 separates a composite video signal S100 output from the AV switch 1200 into a luminance signal S120 and a color signal S119. The color demodulator circuit 1400 demodulates the color signal S119 output from the Y/C separation circuit 1300 to a U signal S40U and a V signal S40V which are color-difference signals. The RGB conversion circuit 1500 converts the luminance signal S120 from the Y/C separation circuit 1300 and the color-difference signals S40U, S40V from the color demodulator circuit 1400 to an R signal S50R, a G signal S50G, and a B signal S50B. The color correction circuit 100 is the color correction device described in the first and second embodiments. The monitor screen 1600 displays a video image based on RGB signals Ro, Go, Bo from the color correction circuit 100. The audio processing circuit 1700 processes an audio signal S100A output from the AV switch 1200. The audio output circuit 1800 amplifies an audio signal S70 output from the audio processing circuit 1700, and outputs an amplified audio signal S80 to the speaker 1900. The speaker 1900 outputs the audio signal S80 output from the audio output circuit 1800.

Note that as an example video image display device including the color correction device, the television receiver has been described in the present embodiment, but such a video image display device may be a liquid crystal display television set, a plasma display television set, an organic EL television set, a video capture board, a personal computer device, a DVD recorder, a Blu-ray Disc recorder, or the like.

A means to execute various functions (e.g., correction value calculation) in the example embodiments described above is not limited to but typically hardware. Some or all of the functions can be executed by hardware, software, or a combination of hardware and software. Some or all of the functions can be described as data which is readable by a computer, and may be stored in a storage medium readable by the computer. The computer reads the data from such a storage medium, so that the computer can perform at least some of the functions in the example embodiments. Examples of such a storage medium includes volatile or nonvolatile medium which is removable or unremovable. Specifically, the storage medium includes optical disks, random access memories (RAMs), read only memories (ROMs), flash memories, hard disk drives, etc.

The present invention is not limited to the above embodiments. The invention may be embodied in other specific forms without departing from the spirit or essential characteristics thereof. The present embodiment is therefore to be considered in all respects as illustrative and not restrictive. The scope of the present invention is indicated by the appended claims rather than by the foregoing description, and all changes which come within the meaning and range of equivalency of the claims are therefore intended to be embraced therein.

The present invention is applicable to, for example, television sets, liquid crystal display television sets, plasma display television sets, organic EL television sets, video capture boards, personal computer devices, DVD recorders, etc. which are configured to output video signals.

What is claimed is:

1. A color correction device comprising:
a color space converter configured to convert an input color signal to hue, saturation, and value;
a hue correction value calculator configured to calculate a hue correction value based on the hue and the value from the color space converter;
a hue corrector configured to correct the hue from the color space converter based on the hue correction value from the hue correction value calculator; and
a color space inverse converter configured to subject the hue corrected by the hue corrector and the saturation and the value from the color space converter to conversion performed in a manner inverse to the conversion performed with the color space converter, wherein
the hue correction value calculator contains individual hue correction functions respectively preset for at least two of red, yellow, green, cyan, blue, and magenta, which are colors of six hue axes,
each of the hue correction functions takes the value as an input parameter, and returns the hue correction value as an output, and
the hue correction value calculator determines to which one of color areas of the red, yellow, green, cyan, blue, and magenta, which are the colors of the six hue axes, the hue from the color space converter belongs, and calculates the hue correction value based on the hue correction function specified for the determined color area and the value from the color space converter.

2. The color correction device of claim 1, wherein
the hue correction value calculator includes a color area determiner, a value level area determiner, a correction amount parameter selector, a correction value calculating circuit, a first look-up table, and a second look-up table,
the first look-up table contains at least two first tables respectively associated with at least two of the color areas of the red, yellow, green, cyan, blue, and magenta, which are the colors of the six hue axes,
each of the first tables specifies preset ranges of the value of N areas obtained by dividing a range from a minimum value to a maximum value of the value of the corresponding color area by N,
the second look-up table contains at least two second tables respectively associated with at least two of the color areas of the red, yellow, green, cyan, blue, and magenta, which are the colors of the six hue axes,
each of the second tables specifies correction amount parameters preset for the N areas of the corresponding color area,
each of the correction amount parameters represents a correction function of the corresponding color area, and the correction function takes the value as an input parameter, and returns the hue correction value as an output,
the color area determiner determines to which one of the color areas of the red, yellow, green, cyan, blue, and magenta, which are the colors of the six hue axes, the hue from the color space converter belongs, and outputs a result of the determination as a color area determination result,
the value level area determiner refers to one of the first tables contained in the first look-up table which corresponds to the color area determination result from the color area determiner, determines to which one of the N areas specified in the table the value from the color space converter belongs, and outputs a result of the determination as a value level determination result,
the correction amount parameter selector refers to one of the second tables contained in the second look-up table which corresponds to the color area determination result from the color area determiner, obtains, from the table, the correction amount parameter specified for the value level determination result from the value level area determiner, and outputs the obtained correction amount parameter, and
the correction value calculating circuit calculates the hue correction value based on the correction amount parameter from the correction amount parameter selector and the value from the color space converter.

3. A color correction device comprising:
a color space converter configured to convert an input color signal to hue, saturation, and value;
a saturation correction value calculator configured to calculate a saturation correction value based on the hue and the value from the color space converter;
a saturation corrector configured to correct the saturation from the color space converter based on the saturation correction value from the saturation correction value calculator; and
a color space inverse converter configured to subject the saturation corrected by the saturation corrector and the hue and the value from the color space converter to conversion performed in a manner inverse to the conversion performed with the color space converter, wherein
the saturation correction value calculator contains individual saturation correction functions respectively preset for at least two of red, yellow, green, cyan, blue, and magenta, which are colors of six hue axes,
each of the saturation correction functions takes the value as an input parameter, and returns the saturation correction value as an output, and
the saturation correction value calculator determines to which one of color areas of the red, yellow, green, cyan, blue, and magenta, which are the colors of the six hue axes, the hue from the color space converter belongs, and calculates the saturation correction value based on the saturation correction function specified for the determined color area and the value from the color space converter.

4. The color correction device of claim 3, wherein
the saturation correction value calculator includes a color area determiner, a value level area determiner, a correction amount parameter selector, a correction value calculating circuit, a first look-up table, and a second look-up table,
the first look-up table contains at least two first tables respectively associated with at least two of the color areas of the red, yellow, green, cyan, blue, and magenta, which are the colors of the six hue axes,
each of the first tables specifies preset ranges of the value of N areas obtained by dividing a range from a minimum value to a maximum value of the value of the corresponding color area by N,
the second look-up table contains at least two second tables respectively associated with at least two of the color areas of the red, yellow, green, cyan, blue, and magenta, which are the colors of the six hue axes,
each of the second tables specifies correction amount parameters preset for the N areas of the corresponding color area,
each of the correction amount parameters represents a correction function of the corresponding color area, and the correction function takes the value as an input parameter, and returns the saturation correction value as an output,
the color area determiner determines to which one of the color areas of the red, yellow, green, cyan, blue, and magenta, which are the colors of the six hue axes, the hue from the color space converter belongs, and outputs a result of the determination as a color area determination result,
the value level area determiner refers to one of the first tables contained in the first look-up table which corresponds to the color area determination result from the color area determiner, determines to which one of the N areas specified in the table the value from the color space converter belongs, and outputs a result of the determination as a value level determination result,
the correction amount parameter selector refers to one of the second tables contained in the second look-up table which corresponds to the color area determination result from the color area determiner, obtains, from the table, the correction amount parameter specified for the value level determination result from the value level area determiner, and outputs the obtained correction amount parameter, and
the correction value calculating circuit calculates the saturation correction value based on the correction amount parameter from the correction amount parameter selector and the value from the color space converter.

5. A color correction device comprising:
a color space converter configured to convert an input color signal to hue, saturation, and value;
a hue correction value calculator configured to calculate a hue correction value based on the hue and the value from the color space converter;
a saturation correction value calculator configured to calculate a saturation correction value based on the hue and the value from the color space converter;
a hue corrector configured to correct the hue from the color space converter based on the hue correction value from the hue correction value calculator;
a saturation corrector configured to correct the saturation from the color space converter based on the saturation correction value from the saturation correction value calculator; and
a color space inverse converter configured to subject the hue corrected by the hue corrector, the saturation corrected by the saturation corrector, and the value from the color space converter to conversion performed in a manner inverse to the conversion performed with the color space converter, wherein
the hue correction value calculator contains individual hue correction functions respectively preset for at least two of red, yellow, green, cyan, blue, and magenta, which are colors of six hue axes,
each of the hue correction functions takes the value as an input parameter, and returns the hue correction value as an output,
the hue correction value calculator determines to which one of color areas of the red, yellow, green, cyan, blue, and magenta, which are the colors of the six hue axes, the hue from the color space converter belongs, and calculates the hue correction value based on the hue correction function specified for the determined color area and the value from the color space converter,
the saturation correction value calculator contains individual saturation correction functions respectively preset for at least two of the red, yellow, green, cyan, blue, and magenta, which are the colors of the six hue axes,
each of the saturation correction functions takes the value as an input parameter, and returns the saturation correction value as an output, and
the saturation correction value calculator determines to which one of color areas of the red, yellow, green, cyan, blue, and magenta, which are the colors of the six hue axes, the hue from the color space converter belongs, and calculates the saturation correction value based on the saturation correction function specified for the determined color area and the value from the color space converter.

6. The color correction device of claim 5, wherein
the hue correction value calculator includes a first color area determiner, a first value level area determiner, a first correction amount parameter selector, a first correction value calculating circuit, a first look-up table, and a second look-up table,
the first look-up table contains at least two first tables respectively associated with at least two of the color areas of the red, yellow, green, cyan, blue, and magenta, which are the colors of the six hue axes,
each of the first tables specifies preset ranges of the value of N areas obtained by dividing a range from a minimum value to a maximum value of the value of the corresponding color area by N,
the second look-up table contains at least two second tables respectively associated with at least two of the color areas of the red, yellow, green, cyan, blue, and magenta, which are the colors of the six hue axes,
each of the second tables specifies first correction amount parameters preset for the N areas of the corresponding color area,
each of the first correction amount parameters represents the hue correction function of the corresponding color area, and the hue correction function takes the value as an input parameter, and returns the hue correction value as an output,
the first color area determiner determines to which one of the color areas of the red, yellow, green, cyan, blue, and magenta, which are the colors of the six hue axes, the hue from the color space converter belongs, and outputs a result of the determination as a color area determination result,
the first value level area determiner refers to one of the first tables contained in the first look-up table which corresponds to the color area determination result from the first color area determiner, determines to which one of the N areas specified in the table the value from the color space converter belongs, and outputs a result of the determination as a value level determination result,
the first correction amount parameter selector refers to one of the second tables contained in the second look-up table which corresponds to the color area determination result from the first color area determiner, obtains, from the table, the first correction amount parameter specified for the value level determination result from the first value level area determiner, and outputs the obtained first correction amount parameter,
the first correction value calculating circuit calculates the hue correction value based on the first correction amount parameter from the first correction amount parameter selector and the value from the color space converter,
the saturation correction value calculator includes a second color area determiner, a second value level area determiner, a second correction amount parameter selector, a second correction value calculating circuit, a third look-up table, and a fourth look-up table,
the third look-up table contains at least two third tables respectively associated with at least two of the color areas of the red, yellow, green, cyan, blue, and magenta, which are the colors of the six hue axes,
each of the third tables specifies preset ranges of the value of N areas obtained by dividing a range from a minimum value to a maximum value of the value of the corresponding color area by N,
the fourth look-up table contains at least two fourth tables respectively associated with at least two of the color areas of the red, yellow, green, cyan, blue, and magenta, which are the colors of the six hue axes,
each of the fourth tables specifies second correction amount parameters preset for the N areas of the corresponding color area,
each of the second correction amount parameters represents a saturation correction function of the corresponding color area, and the saturation correction function takes the value as an input parameter, and returns the saturation correction value as an output,
the second color area determiner determines to which one of the color areas of the red, yellow, green, cyan, blue, and magenta, which are the colors of the six hue axes, the hue from the color space converter belongs, and outputs a result of the determination as a color area determination result,
the second value level area determiner refers to one of the third tables contained in the third look-up table which corresponds to the color area determination result from the second color area determiner, determines to which one of the N areas specified in the table the value from the color space converter belongs, and outputs a result of the determination as a value level determination result,
the second correction amount parameter selector refers to one of the fourth tables contained in the fourth look-up table which corresponds to the color area determination result from the second color area determiner, obtains, from the table, the second correction amount parameter specified for the value level determination result from the second value level area determiner, and outputs the obtained second correction amount parameter, and
the second correction value calculating circuit calculates the saturation correction value based on the second correction amount parameter from the second correction amount parameter selector and the value from the color space converter.

7. A color correction method comprising:
a color space conversion step of converting an input color signal to hue, saturation, and value;
a hue correction value calculating step of calculating a hue correction value based on the hue and the value obtained in the color space conversion step;
a hue correction step of correcting the hue obtained in the color space conversion step based on the hue correction value obtained in the hue correction value calculating step; and
a color space inverse conversion step of subjecting the corrected hue obtained in the hue correction step and the saturation and the value obtained in the color space conversion step to conversion performed in a manner inverse to the conversion performed in the color space conversion step, wherein
in the hue correction value calculating step, individual hue correction functions are respectively preset for at least two of red, yellow, green, cyan, blue, and magenta, which are colors of six hue axes,
each of the hue correction functions takes the value as an input parameter, and returns the hue correction value as an output, and
in the hue correction value calculating step, it is determined to which one of color areas of the red, yellow, green, cyan, blue, and magenta, which are the colors of the six hue axes, the hue obtained in the color space conversion step belongs, and the hue correction value is calculated based on the hue correction function specified for the determined color area and the value obtained in the color space conversion step.

8. A color correction method comprising:
a color space conversion step of converting an input color signal to hue, saturation, and value;
a saturation correction value calculating step of calculating a saturation correction value based on the hue and the value obtained in the color space conversion step;
a saturation correction step of correcting the saturation obtained in the color space conversion step based on the saturation correction value obtained in the saturation correction value calculating step; and
a color space inverse conversion step of subjecting the corrected saturation obtained in the saturation correction step and the hue and the value obtained in the color space conversion step to conversion performed in a manner inverse to the conversion performed in the color space conversion step, wherein
in the saturation correction value calculating step, individual saturation correction functions are respectively preset for at least two of red, yellow, green, cyan, blue, and magenta, which are colors of six hue axes,
each of the saturation correction functions takes the value as an input parameter, and returns the saturation correction value as an output, and
in the saturation correction value calculating step, it is determined to which one of color areas of the red, yellow, green, cyan, blue, and magenta, which are the colors of the six hue axes the hue obtained in the color space conversion step belongs, and the saturation correction value is calculated based on the saturation correction function specified for the determined color area and the value obtained in the color space conversion step.

9. A color correction method comprising:
a color space conversion step of converting an input color signal to hue, saturation, and value;
a hue correction value calculating step of calculating a hue correction value based on the hue and the value obtained in the color space conversion step;
a saturation correction value calculating step of calculating a saturation correction value based on the hue and the value obtained in the color space conversion step;
a hue correction step of correcting the hue obtained in the color space conversion step based on the hue correction value obtained in the hue correction value calculating step;
a saturation correction step of correcting the saturation obtained in the color space conversion step based on the saturation correction value obtained in the saturation correction value calculating step; and
a color space inverse conversion step of subjecting the corrected hue obtained in the hue correction step, the corrected saturation obtained in the saturation correction step, and the value obtained in the color space conversion step to conversion performed in a manner inverse to the conversion performed in the color space conversion step, wherein
in the hue correction value calculating step, individual hue correction functions are respectively preset for at least two of red, yellow, green, cyan, blue, and magenta, which are colors of six hue axes,
each of the hue correction functions takes the value as an input parameter, and returns the hue correction value as an output,
in the hue correction value calculating step, it is determined to which one of color areas of the red, yellow, green, cyan, blue, and magenta, which are the colors of the six hue axes, the hue obtained in the color space conversion step belongs, and the hue correction value is calculated based on the hue correction function specified for the determined color area and the value obtained in the color space conversion step,
in the saturation correction value calculating step, individual saturation correction functions are respectively preset for at least two of red, yellow, green, cyan, blue, magenta, which are colors of six hue axes,
each of the saturation correction functions takes the value as an input parameter and the saturation correction value as an output, and
in the saturation correction value calculating step, it is determined to which one of the color areas of the red, yellow, green, cyan, blue, and magenta, which are the colors of the six hue axes, the hue obtained in the color space conversion step belongs, and the saturation correction value is calculated based on the saturation correction function specified for the determined color area and the value obtained in the color space conversion step.

10. A video image display comprising:
the color correction device of claim 1.
